(19) United States
(12) Patent Application Publication
(10) Pub. No.: US 2025/0101171 A1
(43) Pub. Date: Mar. 27, 2025

(54) MODIFIED POLYETHYLENE TEREPHTHALATE COPOLYESTER AND PREPARATION METHOD THEREOF

(71) Applicant: NAN YA PLASTICS CORPORATION, Taipei City (TW)

(72) Inventors: Te-Chao Liao, Taipei City (TW); Chi-Lin Chen, Taipei City (TW); Wen-Hua Lu, Taipei City (TW)

(73) Assignee: NAN YA PLASTICS CORPORATION, Taipei City (TW)

(21) Appl. No.: 18/494,780

(22) Filed: Oct. 26, 2023

(30) Foreign Application Priority Data
Sep. 27, 2023 (TW) 112137038

(51) Int. Cl. C08G 63/91

(52) U.S. Cl. CPC C08G 63/916

(57) ABSTRACT

A modified polyethylene terephthalate copolyester, including three fragments shown as [Fragment 1], [Fragment 2], and [Fragment 3] in the specification, is provided.

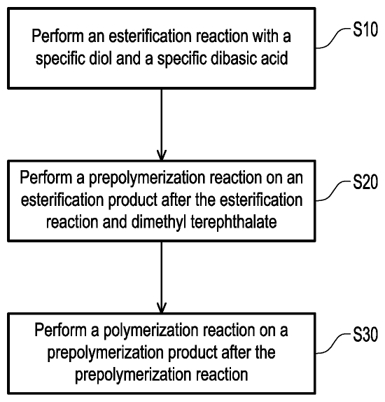

### CROSS-REFERENCE TO RELATED APPLICATION

This application claims the priority benefit of Taiwan application serial no. 112137038, filed on Sep. 27, 2023. The entirety of the above-mentioned patent application is hereby incorporated by reference herein and made a part of this specification.

### BACKGROUND

### Technical Field

The disclosure relates to a polymer and a preparation method thereof, and in particular to a modified polyethylene terephthalate copolyester and a preparation method thereof.

### Description of Related Art

Polyethylene terephthalate (PET) is made from the condensation reaction of terephthalic acid and ethylene glycol. Polyethylene terephthalate has high strength, high rigidity, good heat resistance, chemical resistance, and electrical insulation performance, so polyethylene terephthalate may be widely applied to fields such as fiber, film, and beverage bottles.

However, when traditional polyethylene terephthalate is used as engineering plastic, issues such as insufficient heat resistance and inability to take into account transparency are often encountered.

### SUMMARY

The disclosure provides a modified polyethylene terephthalate copolyester, which includes specific fragments.

The modified polyethylene terephthalate copolyester of the disclosure includes three fragments, [Fragment 1], [Fragment 2], and [Fragment 3], below.

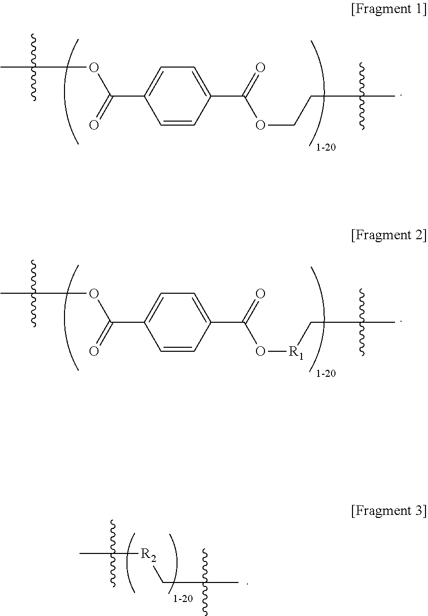

In [Fragment 2], R₁ is a linking group of one of [Formula A1], [Formula A2], and [Formula A3] below.

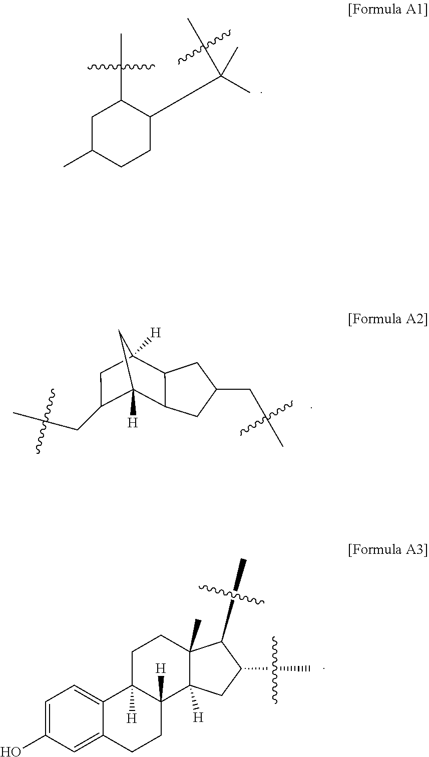

In [Fragment 3], R₂ is a linking group of one of [Formula B1], [Formula B2], and [Formula B3] below.

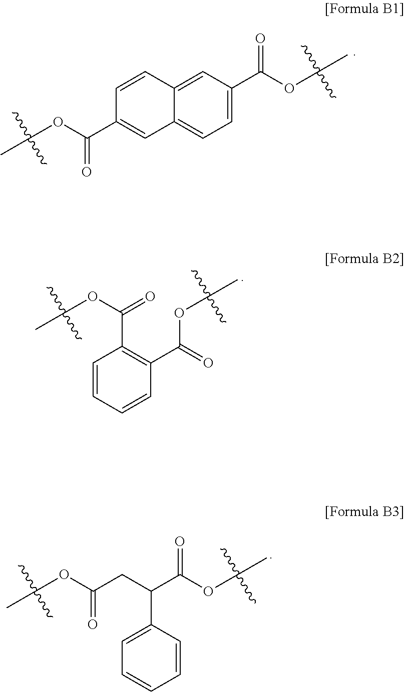 [SMILES: *OC(=O)c1ccc2cc(C(=O)O*)ccc2c1 ; *OC(=O)c1ccccc1C(=O)O* ; *OC(=O)CC(C(=O)O*)c1ccccc1]

The preparation method of the modified polyethylene terephthalate copolyester of the disclosure includes the following steps. An esterification reaction is performed with a diol of at least one of [Formula A1-1], [Formula A2-1], and [Formula A3-1], and a dibasic acid of at least one of [Formula B1-1], [Formula B2-1], and [Formula B3-1]. A prepolymerization reaction is performed on an esterification product after the esterification reaction and dimethyl terephthalate (DMT). A polymerization reaction is performed on a prepolymerization product after the prepolymerization reaction.

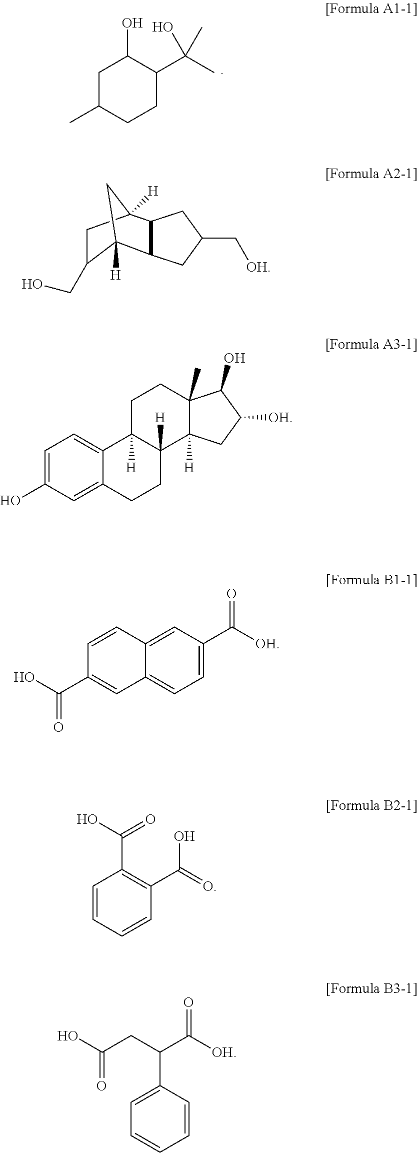

Based on the above, the modified polyethylene terephthalate copolyester of the disclosure has at least specific fragments to have a relatively wide applicability.

### BRIEF DESCRIPTION OF THE DRAWINGS

FIGURE is a partial flow diagram of a preparation method of modified polyethylene terephthalate copolyester according to an embodiment of the disclosure.

### DESCRIPTION OF THE EMBODIMENTS

In the following detailed description, for purposes of illustration and not limitation, exemplary embodiments disclosing specific details are set forth in order to provide a thorough understanding of the various principles of the invention. It will be apparent, however, to one of ordinary skill in the art, having the benefit of this disclosure, that the invention may be practiced in other embodiments that depart from the specific details disclosed herein. Moreover, descriptions of well-known devices, methods, and materials may be omitted so as not to obscure the description of the various principles of the invention.

Ranges may be expressed herein as from “about” one particular value to “about” another particular value and may also be expressed directly as one particular value and/or to another particular value. When expressing the range, another embodiment includes from the one particular value and/or to another particular value. Similarly, when values are expressed as approximations by use of the antecedent “about,” it will be understood that the particular value forms another embodiment. It will be further understood that an endpoint of each range is expressly related to the other endpoint or unrelated to the other endpoint.

Non-limiting terms (such as may, can, for example, or other similar terms) herein refer to an optional or selective implementation, inclusion, addition, or presence.

Unless otherwise defined, all terms (including technical terms and scientific terms) used herein have the same meaning as commonly understood by one of ordinary skill in the art to which this invention belongs. It should be understood that terms (such as those defined in commonly used dictionaries) should be interpreted as having meanings consistent with their meanings in the relevant technical background and should not be interpreted in an idealized or overly formal sense, unless expressly so defined herein.

### Modified Polyethylene Terephthalate Copolyester

The modified polyethylene terephthalate copolyester of the disclosure includes at least the three fragments (that is, [Fragment 1], [Fragment 2], and [Fragment 3]) below.

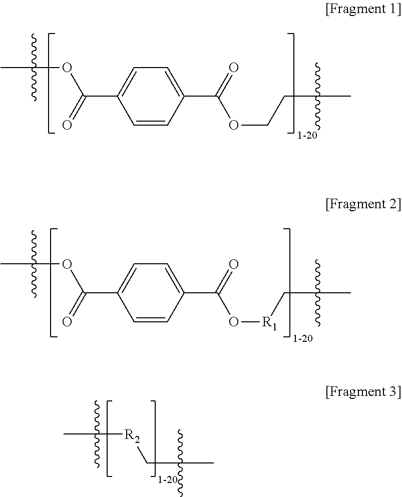

In [Fragment 2], R₁ is a linking group of one of [Formula A1], [Formula A2], and [Formula A3] below.

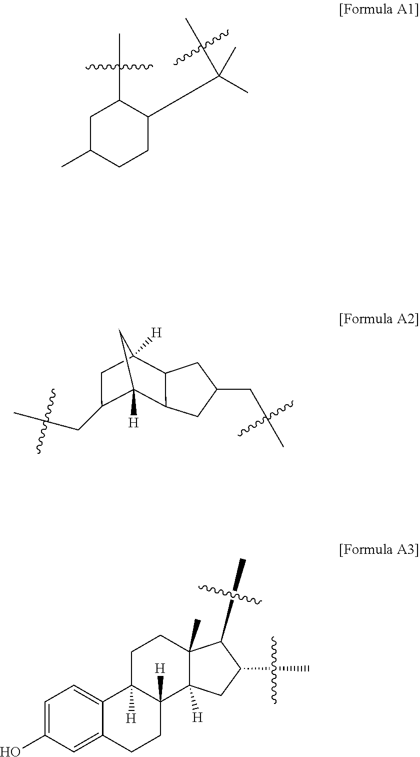

Preferably, in [Fragment 2], R₁ is the linking group of [Formula A3].

In [Fragment 3], R₂ is a linking group of one of [Formula B1], [Formula B2], and [Formula B3] below.

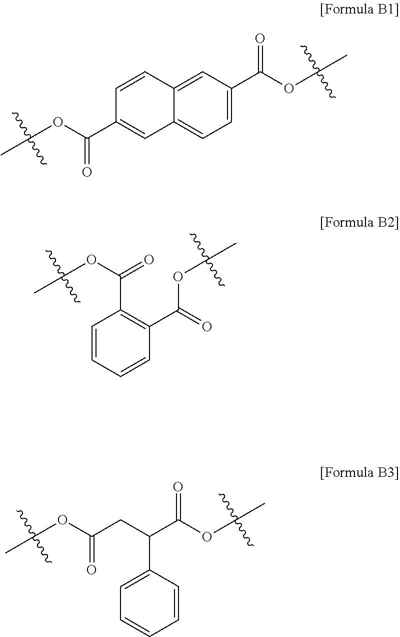 [SMILES: *OC(=O)c1ccc2cc(C(=O)O*)ccc2c1 ; *OC(=O)c1ccccc1C(=O)O* ; *OC(=O)CC(C(=O)O*)c1ccccc1]

Preferably, in [Fragment 3], R₂ is the linking group of [Formula B1].

In an embodiment, in one unit of the modified polyethylene terephthalate copolyester, the molar ratio of [Fragment 1] is greater than the molar ratio of [Fragment 2] and the molar ratio of [Fragment 3].

In an embodiment, in one unit of the modified polyethylene terephthalate copolyester, the molar ratio of [Fragment 1] is greater than or equal to the total molar ratio of [Fragment 2] and [Fragment 3]. For example, the molar ratio of [Fragment 1] may be 1 to 2.5 times the total molar ratio of [Fragment 2] and [Fragment 3]. For example, the molar ratio of [Fragment 1] may be 1 to 2 times the total molar ratio of [Fragment 2] and [Fragment 3]. For example, the molar ratio of [Fragment 1] may be 1 to 1.5 times the total molar ratio of [Fragment 2] and [Fragment 3].

In an embodiment, in one unit of the modified polyethylene terephthalate copolyester, the molar ratios of [Fragment 2] and [Fragment 3] may be 1:3 to 2:1. For example, the molar ratios of [Fragment 2] to [Fragment 3] may be 1:3 to 1:1.

The modified polyethylene terephthalate copolyester may have high transparency. For example, in a state with a thickness of about 0.32 millimeters (mm), the light transmittance in the visible light range may be greater than 90%.

The modified polyethylene terephthalate copolyester may have high haze. For example, the surface haze of the modified polyethylene terephthalate copolyester may be greater than 5.

The modified polyethylene terephthalate copolyester may have high impact strength. For example, the Izod impact strength test is performed with the same or similar test standard as ASTM D 256, and the impact strength of the modified polyethylene terephthalate copolyester may be greater than 5 kg/cm².

### Preparation Method of Modified Polyethylene Terephthalate Copolyester

The preparation of the modified polyethylene terephthalate copolyester may apply the equipment used in the preparation of general polyesters (for example, polyethylene terephthalate (PET) or polyethylene naphthalate (PEN)), and the difference only lies in the addition or the difference of raw materials or the adjustment of preparation conditions (for example, temperature, pressure, rate, etc.). Therefore, the preparation of the modified polyethylene terephthalate copolyester may be easier or more convenient. The preparation manner of the modified polyethylene terephthalate copolyester may be as follows.

### Esterification Reaction

An esterification reaction is performed with a diol of one of [Formula A1-1], [Formula A2-1], and [Formula A3-1], and a dibasic acid of one of [Formula B1-1], [Formula B2-1], and [Formula B3-1] to generate a corresponding ester.

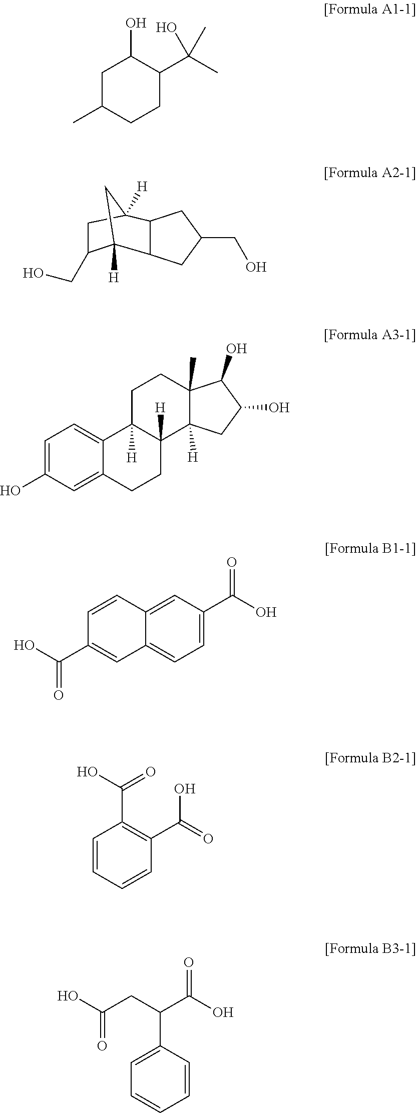

In an embodiment, the diol shown in [Formula A3-1] is used. In an embodiment, the dibasic acid shown in [Formula B1-1] is used. In an embodiment, the diol shown in [Formula A3-1] is used, and the dibasic acid shown in [Formula B1-1] is used.

In an embodiment, the diol shown in [Formula A1-1] is used. In an embodiment, the dibasic acid shown in [Formula B3-1] is used. In an embodiment, the diol shown in [Formula A1-1] is used, and the dibasic acid shown in [Formula B3-1] is used.

In an embodiment, the esterification reaction may be performed in a common esterification tank.

In an embodiment, the esterification reaction may be performed under the reaction condition of 150° C. to 300° C. In an embodiment, the esterification reaction may be performed for about 1 hour to 3 hours. In an embodiment, the esterification reaction may be performed under the reaction condition of 150° C. to 300° C. for about 1 hour to 3 hours.

In an embodiment, an appropriate catalyst may be added to the esterification reaction. The catalyst may be added in an amount of 1 wt % to 10 wt % based on the weight of the dibasic acid or diol mixture. The catalyst is, for example, sulfuric acid.

In an embodiment, in the esterification reaction, the molar number of the diol may be greater than or equal to the molar number of the dibasic acid. In an embodiment, the molar ratio of the dibasic acid to the diol may be 1:1 to 1:2. Preferably, the molar number of the diol may be greater than the molar number of the dibasic acid. In an embodiment, the molar ratio of the dibasic acid to the diol may be 1:1.05 to 1:2.

In an embodiment, the esterification reaction may be performed under a normal pressure state (that is, about 1 atmosphere).

### Prepolymerization Reaction

A prepolymerization reaction may be performed on the product of the esterification reaction and dimethyl terephthalate (DMT). In an embodiment, the product of the esterification reaction may include a corresponding ester product. In an embodiment, the product of the prepolymerization reaction may include the corresponding ester product and remaining alcohols.

In an embodiment, the prepolymerization reaction may be performed in a common condensation tank.

In an embodiment, in the prepolymerization reaction, the usage amount (expressed by weight) of dimethyl terephthalate (DMT) is 0.5 to 2 times the ester product of the esterification reaction.

In an embodiment, the prepolymerization reaction may be performed under the reaction condition of 200° C. to 300° C. In an embodiment, the prepolymerization reaction may be performed for about 1 hour to 3 hours. In an embodiment, the prepolymerization reaction may be performed under the reaction condition of 200° C. to 300° C. for about 1 hour to 3 hours.

In an embodiment, an appropriate catalyst may be added to the prepolymerization reaction. The amount of the catalyst added may be 100 ppm to 1000 ppm based on the weight of the reactant in the prepolymerization reaction. The catalyst is, for example, an antimony catalyst (for example, antimony trioxide) or other suitable catalysts. In an embodiment, the catalyst may be added at a later stage (for example, after first reacting for 0.5 hours, 1 hour, or 2 hours) of the prepolymerization reaction, which can reduce the loss of the catalyst caused by alcohols during the reaction process and can improve the reaction efficiency of the prepolymerization reaction and/or a vacuum polymerization reaction described below.

In an embodiment, the prepolymerization reaction may be performed under a low pressure state (that is, less than 1 atmosphere; about 0.1 to 0.8 atmospheres).

After performing the esterification reaction on the dibasic acid and the diol, the molecular weight of the ester product of the esterification reaction is usually low (such as less than 1000 g/mol). In the presence of excess diol, if the vacuum polymerization reaction described below is directly performed (that is, the prepolymerization reaction is not performed), the pipeline of a polymerization device may be easily blocked and/or the material may be lost, which may further directly cause the failure of the vacuum polymerization reaction. The prepolymerization reaction in a low pressure environment may reduce the possibility of the above situations.

### Vacuum Polymerization Reaction

The prepolymerization product of the prepolymerization reaction may be used to perform the vacuum polymerization reaction. In an embodiment, the prepolymerization product of the prepolymerization reaction may include a corresponding product (for example, a polymer or an oligomer with a shorter chain length). In an embodiment, the prepolymerization product of the prepolymerization reaction may include the corresponding product and the catalyst used in the prepolymerization reaction. In an embodiment, a catalyst used in the vacuum polymerization reaction may be the same or similar to the catalyst used in the prepolymerization reaction. In an embodiment, an appropriate or an appropriate amount of a catalyst may be additionally added to the vacuum polymerization reaction.

In an embodiment, the vacuum polymerization reaction may be performed in a common condensation tank. In an embodiment, the vacuum polymerization reaction may continue to use the reaction equipment used in the prepolymerization reaction. In other words, after completing the prepolymerization reaction, the vacuum polymerization reaction may continue to be performed in the same equipment.

In an embodiment, the vacuum polymerization reaction may be performed in a vacuum state (that is, less than or equal to 0.4 atmospheres).

In an embodiment, the vacuum polymerization reaction may be performed under the reaction condition of 250° C. to 350° C. In an embodiment, the vacuum polymerization reaction may be performed for about 1 hour to 2 hours. In an embodiment, the vacuum polymerization reaction may be performed under the reaction condition of 250° C. to 350° C. for about 1 hour to 2 hours.

In an embodiment, the end time of the vacuum polymerization reaction may be adjusted according to the condition of the product. In an embodiment, if the torque value of a stirrer is greater than or equal to 130 W, vacuum may be broken (such as by filling in nitrogen). Furthermore, the pressure in the condensation tank may be increased, so that a melt is pressed out, and is then water-cooled and pelletized in a pelletizer to become a corresponding modified polyethylene terephthalate copolyester pellet.

### Examples and Comparative Examples

Examples and comparative examples are shown below to specifically explain the disclosure, but the disclosure is not limited at all by the following examples.

The modified polyethylene terephthalate copolyester may be produced by the above manner. The differences between the examples mainly lie in the different ratios of the fragments. The fragment ratio may be directly estimated by the usage amount of the reactant or may be measured and estimated by a common analysis manner (for example, infrared spectroscopy).

The fragment ratio/composition and comparison of each example and each comparative example are shown in [Table 1]. It is worth noting that in each example of [Table 1], the ratio expressed in the fragment ratio item is the molar ratio of [Fragment 1]:[Fragment 2]:[Fragment 3]. Taking Example 3 as an example, in a certain portion, the modified polyethylene terephthalate copolyester thereof has 6 moles of [Fragment 1], 1 mole of [Fragment 2], and 3 moles of [Fragment 3].

In Example 1 to Example 3, the diol used is the diol shown in [Formula A3-1], and the dibasic acid used is the dibasic acid shown in [Formula B1-1]. In other words, in Example 1 to Example 3, in [Fragment 2] thereof, R₁ is a linking group of [Formula A3], and in [Fragment 3] thereof, R₂ is a linking group of [Formula B1].

In Example 4, the diol used is the diol shown in [Formula A1-1], and the dibasic acid used is the dibasic acid shown in [Formula B3-1]. In other words, in Example 4, in [Fragment 2] thereof, R₁ is a linking group of [Formula A1], and in [Fragment 3] thereof, R₂ is a linking group of [Formula B3].

In Example 1 to Example 4, except for the types or the ratios of the diol and the dibasic acid used in the esterification reaction, other conditions (for example, reaction time, reaction temperature, reaction pressure, amount of dimethyl terephthalate added, etc.) are basically the same or similar.

In addition, Comparative Example A may be commercially available polyethylene terephthalate (PET) (sold by Nan Ya Plastics Corporation, available in virgin chip form). In addition, Comparative Example B may be commercially available polyethylene naphthalate (PEN) (sold by Nan Ya Plastics Corporation, available in virgin chip form).

TABLE 1

| | Example | Example | Example | Example | Comparative | Comparative |
|---|---|---|---|---|---|---|
| | 1 | 2 | 3 | 4 | Example A | Example B |
| Fragment | 6:2:2 | 2:1:1 | 6:1:3 | 7:2:1 | PET | PEN |
| ratio/composition | | | | | | |
| Tg (° C.) | 107.6 | 112.9 | 111.6 | 97.2 | 78 | 105 |
| HDT (° C.) | 91.3 | 96.8 | 93.8 | 80.1 | 60.4 | 87.2 |
| Light | 85 | 83 | 87 | 85 | 88 | 86 |
| transmittance (%) | | | | | | |
| IV(dl/g) | 0.67 | 0.54 | 0.65 | 0.66 | 0.67 | 0.51 |

Each test manner may adopt a manner commonly used in the relevant resin field and is illustrated below.

Temperature of glass transition (Tg) (unit: ° C.) test: a differential scanning calorimeter (DSC) was used for analysis with a heating rate of about 20° C./min.

Heat deflection temperature (HDT) (unit: ° C.): same or similar to ASTM D648 and/or ISO 75 standards, an object under test was placed on two supporting points, and an appropriate force was applied in the middle of the object under test, so that the center of the object under test or the internal stress nearby was about 0.46 MPa. Then, the entire device was heated. Also, the corresponding temperature when the deflection in the middle of the object under test was about 0.25 mm was recorded.

Light transmittance (expressed in %): the object under test was analyzed using a light transmittance meter in a state with a thickness of about 0.32 mm (for example, a thin sheet).

Intrinsic viscosity (IV) (unit: dL/g): about 0.125 g of the object under test is obtained, dissolved in 25 ml of mixed solvent (phenol/trichloroethane), heated to 124° C., measured using AVS370 viscosity tester (SI Analytics), and stirred at 330 rpm with stirring motor.

As shown in [Table 1], compared with a commercially available polyester (for example, PET of Comparative Example A or PEN of Comparative Example B), the modified polyethylene terephthalate copolyester of the example has similar light transmittance and/or intrinsic viscosity, and may be applicable to the application and/or the processing and manufacturing manners of the commercially available polyester.

As shown in [Table 1], compared with a commercially available polyethylene terephthalate (for example, Comparative Example A), the modified polyethylene terephthalate copolyester of the example may have a higher temperature of glass transition and heat deflection temperature, better heat resistance, and may be applicable to higher temperature environments.

As shown in [Table 1], compared with a commercially available polyethylene naphthalate (for example, Comparative Example B), the modified polyethylene terephthalate copolyesters of Example 1 to Example 3 may have a higher temperature of glass transition and heat deflection temperature, better heat resistance, and may be applicable to higher temperature environments.

In summary, the modified polyethylene terephthalate copolyester of the disclosure has at least specific fragments, and thus has a higher temperature of glass transition and heat deflection temperature. Moreover, the modified polyethylene terephthalate copolyester of the disclosure has little difference in light transmittance and/or intrinsic viscosity from the commercially available polyester, so the modified polyethylene terephthalate copolyester of the disclosure may be applicable to the application and/or the processing and manufacturing manners of the commercially available polyester.

### INDUSTRIAL APPLICABILITY

The modified polyethylene terephthalate copolyester of the above embodiments of the disclosure may basically be applicable to at least the application manner of the commercially available polyester, but may be applied more widely. For example, containers or films made of the commercially available polyester may be less suitable for containing or wrapping objects with higher temperatures, but the modified polyethylene terephthalate copolyester of the disclosure has a higher temperature of glass transition and heat deflection temperature, so the modified polyethylene terephthalate copolyester of the disclosure may still be applicable at higher temperatures. Moreover, since the modified polyethylene terephthalate copolyester of the disclosure has good light transmittance, the state of the content may be directly observed visually similar to the usage manner of the containers made of the commercially available polyester.

What is claimed is:

1. A modified polyethylene terephthalate copolyester, comprising three fragments, [Fragment 1], [Fragment 2], and [Fragment 3], below: 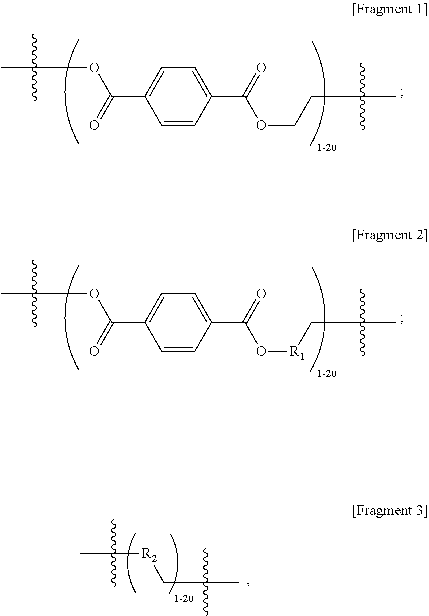
wherein in [Fragment 2], R₁ is a linking group of one of [Formula A1], [Formula A2], and [Formula A3] below: 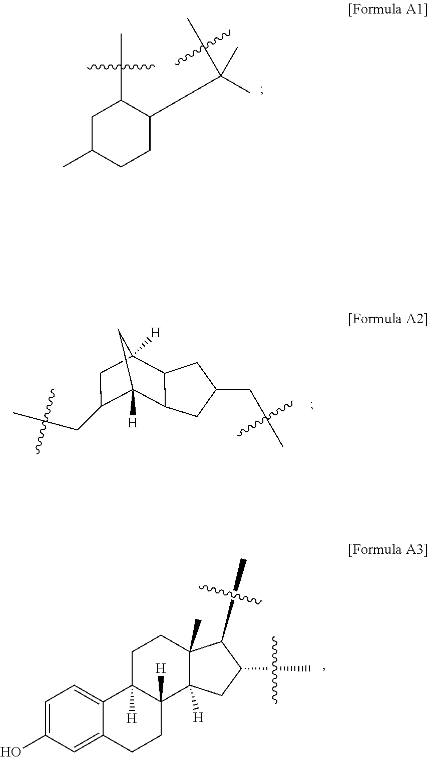
wherein in [Fragment 3], R₂ is a linking group of one of [Formula B1], [Formula B2], and [Formula B3] below:

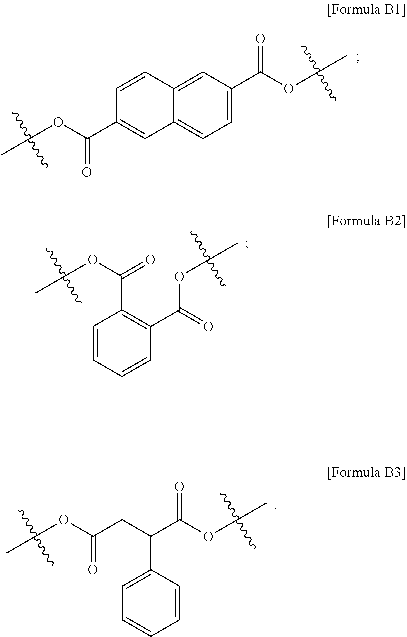 [SMILES: *OC(=O)c1ccc2cc(C(=O)O*)ccc2c1 ; *OC(=O)c1ccccc1C(=O)O* ; *OC(=O)CC(C(=O)O*)c1ccccc1]

2. The modified polyethylene terephthalate copolyester according to claim 1, wherein a molar ratio of [Fragment 1] is greater than a molar ratio of [Fragment 2] and a molar ratio of [Fragment 3].

3. The modified polyethylene terephthalate copolyester according to claim 2, wherein the molar ratio of [Fragment 1] is greater than or equal to a total molar ratio of [Fragment 2] and [Fragment 3].

4. The modified polyethylene terephthalate copolyester according to claim 2, wherein the molar ratios of [Fragment 2] and [Fragment 3] are 1:3 to 2:1.

5. The modified polyethylene terephthalate copolyester according to claim 1, wherein R₁ in [Fragment 2] is a linking group of [Formula A3], and R₂ in [Fragment 3] is a linking group of [Formula B1].

6. A preparation method of a modified polyethylene terephthalate copolyester, comprising:
performing an esterification reaction with a diol of at least one of [Formula A1-1], [Formula A2-1], and [Formula A3-1], and a dibasic acid of at least one of [Formula B1-1], [Formula B2-1], and [Formula B3-1];
performing a prepolymerization reaction on an esterification product after the esterification reaction and dimethyl terephthalate; and
performing a polymerization reaction on a prepolymerization product after the prepolymerization reaction, wherein

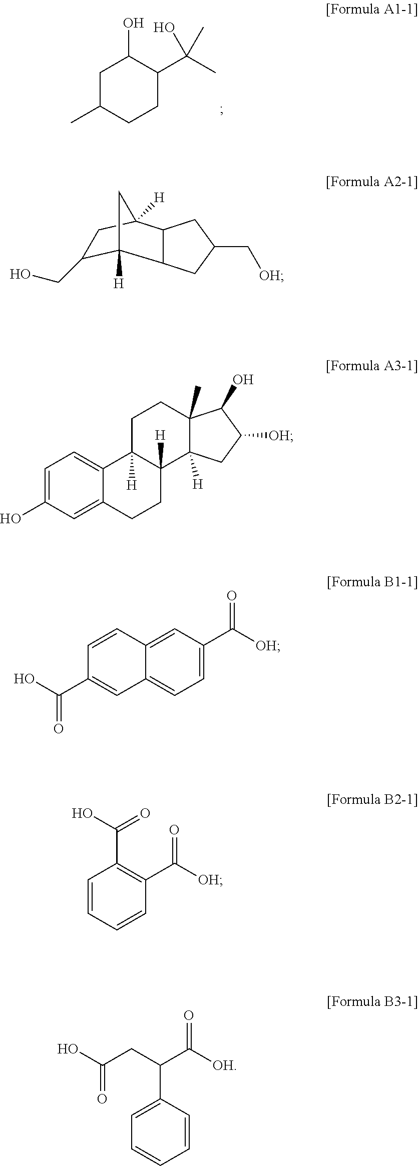

7. The preparation method of the modified polyethylene terephthalate copolyester according to claim 6, wherein an air pressure when performing the esterification reaction is greater than an air pressure when performing the prepolymerization reaction, and the air pressure when performing the prepolymerization reaction is greater than an air pressure when performing the polymerization reaction.

8. The preparation method of the modified polyethylene terephthalate copolyester according to claim 6, wherein a temperature when performing the esterification reaction is 150° C. to 300° C., and/or a time for performing the esterification reaction is 1 hour to 3 hours.

9. The preparation method of the modified polyethylene terephthalate copolyester according to claim 6, wherein a temperature when performing the prepolymerization reaction is 200° C. to 300° C., and/or a time for performing the prepolymerization reaction is 1 hour to 3 hours.

10. The preparation method of the modified polyethylene terephthalate copolyester according to claim 6, wherein a temperature when performing the polymerization reaction is 250° C. to 350° C., and/or a time for performing the polymerization reaction is 1 hour to 2 hours.
